(19) United States
(12) Patent Application Publication
(10) Pub. No.: US 2013/0153484 A1
(43) Pub. Date: Jun. 20, 2013

(54) FLUID SEPARATORS EMPLOYING A FLUIDIC BEARING

(71) Applicants: Salvatore Manzella, JR., Barrington, IL (US); Richard L. West, Lake Villa, IL (US)

(72) Inventors: Salvatore Manzella, JR., Barrington, IL (US); Richard L. West, Lake Villa, IL (US)

(73) Assignee: FENWAL, INC., Lake Zurich, IL (US)

(21) Appl. No.: 13/805,751

(22) PCT Filed: Jun. 27, 2011
(86) PCT No.: PCT/US11/41994

§ 371 Date: Feb. 11, 2013

Related U.S. Application Data
(60) Provisional application No. 61/362,095, filed on Jul. 7, 2010.

(51) Int. Cl. F16C 32/06; B23P 15/00; B01D 63/16

(52) U.S. Cl. CPC F16C 32/067; B01D 63/16; B23P 15/003
USPC 210/321.68; 384/114; 29/898.09

(57) ABSTRACT

A fluid separation device is provided with an outer housing and a rotor rotatably received within the outer housing. The rotor housing has a first end and a second end. The outer surface of the rotor and/or the inner surface of the outer housing is adapted to allow passage of a fluid component through the surface. The device further includes a flexible seal associated with one of the ends of the rotor and adapted to allow for rotational, non-axial, and axial movement of the rotor with respect to the outer housing.

### CROSS-REFERENCE TO RELATED APPLICATIONS

This application claims the benefit of U.S. provisional patent application No. 61/362,095, filed Jul. 7, 2010, which is hereby incorporated herein by reference.

### BACKGROUND

1. Field of the Disclosure

The present subject matter relates to a bearing system for a spinning membrane-type fluid separator.

2. Description of Related Art

Techniques for the separation and collection of given constituents of whole blood are in wide use for many therapeutic, medical and experimental applications. In blood separation procedures, one or more blood constituents, such as plasma, may be collected from individual donors by withdrawing whole blood, separating the constituent, and returning the remaining constituents to the donor. Plasmapheresis may be carried out by various means, including by centrifugation and by membrane filtration. One method of plasmapheresis by membrane filtration is described in U.S. Pat. No. 5,194,145 to Schoendorfer, which is hereby incorporated herein by reference. A cylindrical, membrane-covered spinner having an interior collection system is disposed within a stationary shell or housing, with a substantially annular gap or space separating the membrane and the shell. Blood is fed into the gap at an end of the device (preferably the top end) and, as the spinner is rotated about its central axis, the blood moves both circumferentially and generally axially through the gap. Plasma is extracted through the membrane to a central flowpath inside the spinner, where it is removed from the other end of the device. The remaining blood constituents are removed from the device at an outlet associated with the gap. Plasma extraction in this device is enhanced by the formation of Taylor vortices at and around the membrane, which arise upon by rotation of the spinner within the shell, as described in greater detail in the Schoendorfer '145 patent.

While the foregoing plasmapheresis system functions adequately, further improvements as to the construction, assembly, and reliability of the device and process are realized in the devices and processes of the present disclosure.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a fluid separation device is provided with an outer housing and a rotor rotatably received within the outer housing. The rotor housing has a first end and a second end. The outer surface of the rotor and/or the inner surface of the outer housing is adapted to allow passage of a fluid component through the surface. The device further includes a flexible seal associated with one of the ends of the rotor and adapted to allow for rotational, non-axial, and axial movement of the rotor with respect to the outer housing.

In another aspect, a bearing system is provided with a static body, a dynamic body, and fluid therebetween. The dynamic body is rotatable about an axis, such that rotation of the dynamic body causes at least a portion of the fluid to rotate. Rotation of the dynamic body also achieves substantial coaxial alignment between the static body and the dynamic body by pressure equilibrium of at least a portion of the rotating fluid acting on the rotating dynamic body.

In yet another aspect, a method is provided for achieving substantial coaxial alignment between a static body and a dynamic body. The method includes providing a static body, a dynamic body, and a fluid therebetween. The static body and at least one end of the dynamic body are relatively movable and, for example, at least one end of the dynamic body is movable out of coaxial alignment with the static body. The dynamic body is rotated about an axis, thereby causing at least a portion of the fluid to rotate. Substantial coaxial alignment of the at least one end of the dynamic body with the static body is achieved by pressure equilibrium of at least a portion of the rotating fluid acting on the rotating dynamic body.

### BRIEF DESCRIPTION OF THE DRAWINGS

FIG. 1 is a diagrammatic front view of a fluid separation device according to an aspect of the present disclosure;

FIG. 2 is a detail view of a flexible seal of the fluid separation device of FIG. 1;

FIG. 3 is a diagrammatic top view of the fluid separation device of FIG. 1, in an aligned condition; and

FIG. 4 is a diagrammatic top view of the fluid separation device of FIG. 1, in a misaligned condition.

### DESCRIPTION OF THE ILLUSTRATED EMBODIMENTS

The embodiments disclosed herein are for the purpose of providing the required description of the present subject matter. They are only exemplary, and may be embodied in various forms. Therefore, specific details disclosed herein are not to be interpreted as limiting the subject matter as defined in the accompanying claims.

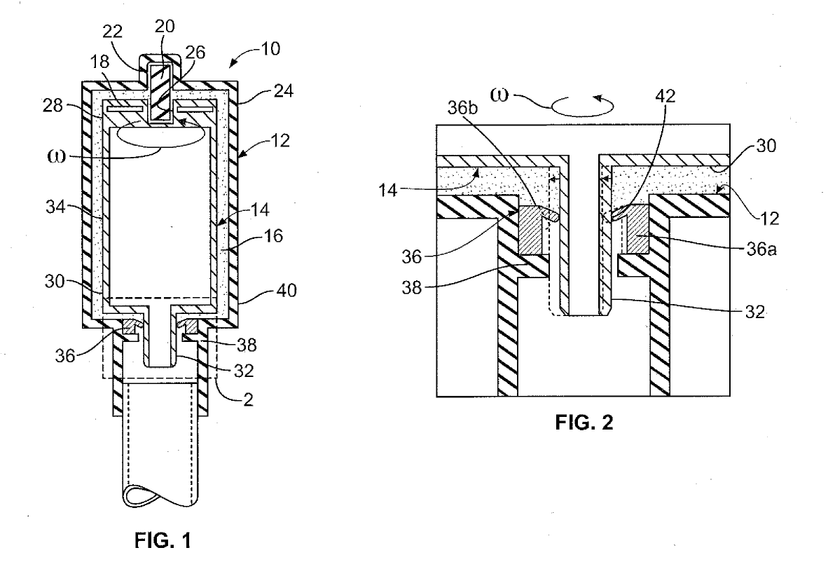

A fluid separation device 10 according to the present disclosure is illustrated in FIG. 1. Fluid separation devices described herein are particularly advantageous for use in the separation of plasma from whole blood, but the same principles may be applied to other fluids and the present disclosure is not restricted to plasmapheresis applications. The fluid separation device 10 comprises a generally cylindrical, stationary outer housing 12 and a generally cylindrical rotor 14 which is rotatably received within the outer housing 12. The outer housing 12 and the rotor 14 are spaced apart by a generally annular gap 16. Also provided is a driver means (not illustrated) for rotating the rotor 14 about its central axis at a speed ω. According to conventional design, the driver means may be an electromagnet adapted to interact with metallic elements 18 of the rotor 14. Other means for rotating the rotor 14 about its central axis may also be employed without departing from the scope of the present disclosure.

In the illustrated embodiment, a rotor pin 20 is aligned with the central axis of the outer housing 12 and the rotor 14. One end of the rotor pin 20 is received within an upper housing bearing 22 at an upper end 24 of the outer housing 12 and the other end of the rotor pin 20 is received within a rotor bearing 26 at an upper or first end 28 of the rotor 14. The rotor pin 20 serves to maintain the upper end 28 of the rotor 14 in generally coaxial alignment with the outer housing 12. As will be described in greater detail below, the rotor pin 20 is an optional feature and may be omitted from the fluid separation device 10.

The lower or second end 30 of the rotor 14 includes a generally tubular fluid outlet 32, which is shown in greater detail in FIG. 2. The outer surface 34 of the rotor 14 may include a membrane which allows passage of a fluid component into the interior of the rotor 14 from fluid present in the gap 16, according to conventional design. The membrane may also be located on the inner surface of the outer housing 12 or on both the rotor 14 and housing 12 to allow passage of a fluid component through the associated surface. In the illustrated embodiment, the fluid outlet 32 removes such separated fluid from the rotor 14. The fluid outlet 32 is received within a flexible seal 36 seated within a generally cylindrical lower housing bearing or recess or well 38 at a lower end 40 of the outer housing 12.

The flexible seal 36 may be comprised of a variety of materials, such as, but not limited to, an elastomeric material, such as neoprene elastomer, silicone, or a fluorocarbon. The illustrated seal 36 has two regions or portions, one of which is referred to herein as a mounting portion 36a and the other which is referred to herein as a flexible seal portion 36b (FIG. 2). The mounting portion 36a as illustrated is a hollow, generally cylindrical structure for close fitting or sealed receipt in the well 38 of the housing 12. The seal portion 36b as illustrated comprises a flexible, generally annular, radially inwardly extending ring or flange (which may be referred to as “doughnut-shaped”), with a central aperture 42 through which the fluid outlet 32 of the rotor 14 extends. The aperture 42 is sized so that the inner peripheral edge of the seal portion 36b contacts the fluid outlet 32 to seal against the escape of liquid. The seal portion 36b is sufficiently thin and flexible to allow some axial misalignment of the rotor 12 without leakage.

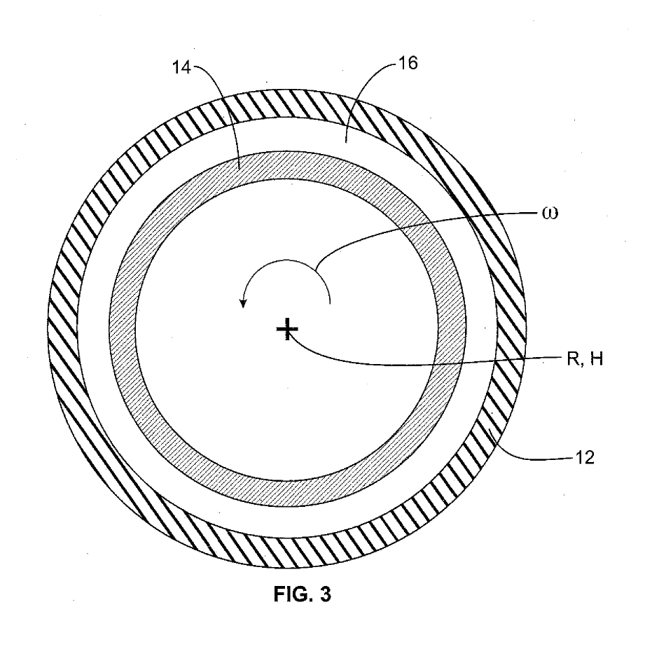

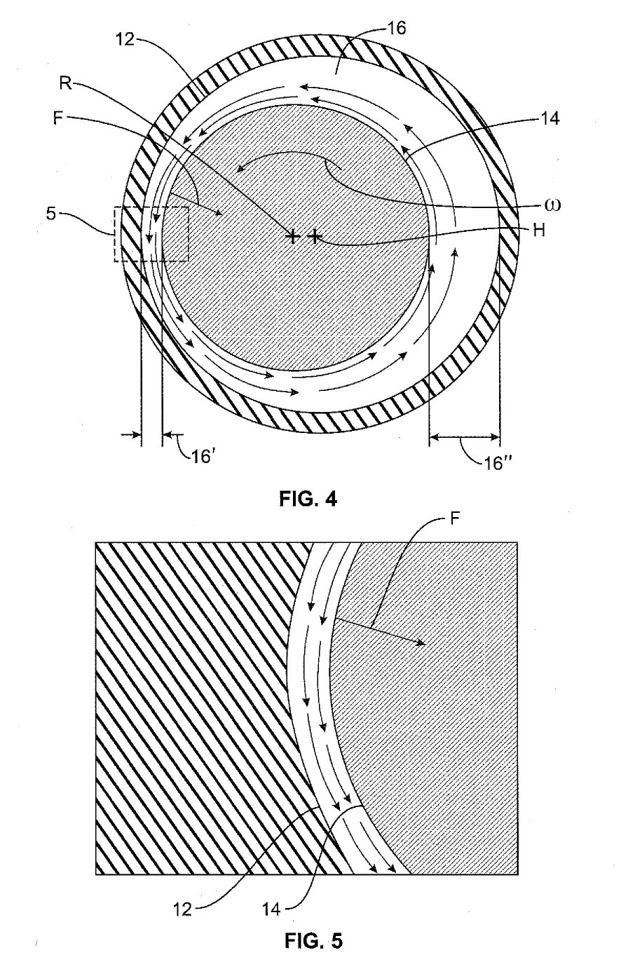

The flexible seal 36 allows rotation of the rotor 14 with respect to the outer housing 12 while preventing leakage of fluid from the gap 16. In contrast to conventional design, the flexible seal 36 also allows movement of the lower end 30 of the rotor 14 out of coaxial alignment with the outer housing 12, as shown in FIGS. 3 and 4. In the condition shown in FIG. 3, the rotor axis R is aligned with the housing axis H, whereas in FIG. 4 the rotor axis R is spaced away from the housing axis H. FIG. 2 shows in solid lines a condition wherein the axes of the rotor 14 and outer housing 12 are aligned (as in FIG. 3), while the broken lines show a condition wherein the rotor axis R is shifted to the left, away from the housing axis H (as in FIG. 4). As illustrated in FIG. 2, the lower housing bearing or well 38 has a diameter which is sufficient to allow for lateral movement of the fluid outlet 32. Misalignment may be the result of movement of the rotor 14 with respect to the outer housing 12, movement of the outer housing 12 with respect to the rotor 14, or movement of both the outer housing 12 and the rotor 14 in different directions.

Conventional fluid separation devices employ a lower housing bearing which is similar to the upper bearing-pin relationship illustrated in FIG. 1, thereby forcing and constraining the rotor to remain in coaxial alignment with the outer housing. It has been found that rigid bearings at the upper and lower ends 28 and 30 of the rotor 14 are unnecessary, as the pressure equilibrium of the fluid moving in the gap 16 causes the rotor 14 to naturally become centered within the outer housing 12. For example, when the rotor 14 shifts laterally to the left during use (FIG. 4), there will be a relatively small gap 16′ to the left of the rotor 14 and a relatively large gap 16″ to the right of the rotor 14. In use, a fluid to be separated is introduced into the gap 16 toward the upper end 24 of the outer housing 12. The viscosity of the fluid in the gap 16 causes at least a portion of the fluid to rotate with the rotating rotor 14. Taylor vortices form at and adjacent to the membrane on the outer surface 34 of the rotor 14 and cause a component of the fluid to pass through the membrane (as described in greater detail in U.S. Pat. No. 5,194,145). The rotating fluid remaining in the gap 16 provides a radially inward force which presses against the rotor 14. The radially inward force acting on the rotor 14 increases as the size of the gap decreases, meaning that the radial force F (FIG. 4) is greatest adjacent to the relatively small gap 16′ and will overcome the opposite radial force adjacent to the relatively large gap 16″ (where the radially inward force is at a minimum). The effect of the radial force F is to force the rotor 14 into coaxial alignment with the outer housing 12, in which condition the size of the gap 16 (and hence the inward radial force acting upon the rotor 14 in all directions) is uniform, which has the effect of maintaining the rotor 14 in proper alignment. Accordingly, it has been found that there is no need for a rigid bearing at either the upper or lower end of the rotor 14.

There are various factors which are believed to contribute to the existence and magnitude of this centering phenomenon. Those factors include the density of the fluid in the gap 16, the rate of rotation ω of the rotor 14, and the size of the gap 16 between the outer housing 12 and the rotor 14. For example, it has been found that an incompressible fluid (e.g., water or blood) will have an improved centering effect as compared to a compressible fluid, such as air. By way of further example, it has been found that for a given fluid and gap size, the centering effect will increase as the rate of rotation ω of the rotor 14 increases. At 3,600 RPM, for example, the centering effect will be very strong and tend to maintain the rotor 14 in coaxial alignment with the outer housing 12 during a plasmapheresis application. In contrast, the centering effect is not as strong at only 600 RPM, which may result in the rotor 14 “wobbling” within the outer housing 12 until the rotational speed ω is increased. In order to avoid any such “wobbling” effect, it may be advantageous for one end of the rotor 14 to be provided with a more traditional, rigid bearing, as shown at the upper end 28 of the rotor 14 of FIG. 1. However, if the nature of the intended use of the fluid separation device 10 is such that “wobbling” at low rotational speeds is acceptable, the illustrated bearing arrangement at the upper end 28 of the rotor 14 may be omitted.

In addition to allowing lateral movement of the rotor 14, the flexible seal 36 also allows movement of the rotor 14 along the rotor axis R. In conventional devices, a downward force is typically applied to the rotor (e.g., by the electromagnet which rotates the rotor) to overcome the buoyancy of the rotor and press it against a seal at the lower housing bearing. In devices 10 according to the present disclosure, the seal at the lower end 30 of the rotor 14 is not improved by applying a downward force to the rotor 14, so the rotor 14 may be left free to “bob” up and down according to its buoyancy without increasing the risk of leakage from the bottom of the gap 16.

It will be seen that, even when a more rigid bearing arrangement is employed at one end of the rotor 14 (as in FIG. 1), a fluid separation device 10 employing a flexible seal 36 has fewer components than conventional devices. The fluidity of the flexible seal 36 also makes it easier to assemble the device 10, as there is no need to strictly ensure alignment of upper and lower bearing assemblies. Additionally, the flexible seal 36 reduces wear, friction, and the opportunity for mechanical failures.

The fluidic bearing of the present disclosure is not limited to fluid separators, but may also be employed in other bearing systems incorporating a dynamic or rotating body and an associated static body. As used herein, the terms “dynamic” and “static” are not intended to be limiting, but to emphasize the relative movement of one body (i.e., the “dynamic” body) with respect to the other body (i.e., the “static” body). In particular, the “static” body is not necessarily static in an absolute sense, but may itself be moving during normal use, whether the movement is minor (e.g., vibrational movement) or more substantial. Hence, the terms “static” and “dynamic” are used to emphasize the movement of one body with respect to the other. Such a bearing system may include a static body (such as, but not limited to, the outer housing 12 of the foregoing description) and a dynamic body (such as, but not limited to, the rotor 14 of the foregoing description) which is rotatable about an axis. The bearing system further includes a fluid between the static body and the dynamic body, with rotation of the dynamic body causing the fluid to rotate (per the foregoing description of the rotating fluid contained in the gap 16 between the outer housing 12 and the rotor 14). In accordance with the principles outlined above, substantial coaxial alignment between the static body and the dynamic body is achieved by pressure equilibrium of the rotating fluid acting on the rotating dynamic body. As used herein, the term “achieve” (and variations thereof) is to be construed broadly to be generally synonymous with “initiating” (e.g., first moving the dynamic body into alignment with the static body), “maintaining” (e.g., keeping the dynamic body in alignment with the static body during use), or both (e.g., moving the dynamic body into alignment with the static body and then keeping the two aligned).

Bearing systems incorporating a fluidic bearing may be incorporated in a variety of different devices, including fluid transfer systems, such as the fluid separation device 10 described herein. In such fluid transfer systems, the dynamic body may be rotatably received within the static body with an inner region of the dynamic body being in fluid communication with an outer region of the static body for transferring a fluid from the interior of the dynamic body to the exterior of the static body. A fluid seal (such as the flexible seal 36 described herein) may be maintained between an outer region of the dynamic body and an inner region of the static body to ensure the presence of fluid between the bodies and, hence, proper alignment of the bodies when the dynamic body is rotating.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof including as combinations of features that are individually disclosed or claimed herein.

1. A fluid separation device comprising:
an outer housing;
a rotor rotatably received within the outer housing and comprising
a first end,
a second end spaced from the first end, and
an outer surface of the rotor and/or an inner surface of the outer housing adapted to allow passage of a fluid component through the surface; and
a flexible seal associated with one of the ends of the rotor and adapted to allow for rotational, non-axial, and axial movement of the rotor with respect to the outer housing.

2. The fluid separation device of claim 1, wherein the first end is an upper end of the rotor, the second end is a lower end of the rotor, and the flexible seal is associated with the second end.

3. The fluid separation device of claim 1, wherein said flexible seal includes a mounting portion positioned against the outer housing and a seal portion extending between the mounting portion and the rotor.

4. The fluid separation device of claim 3, wherein the mounting portion of the flexible seal is generally cylindrical and the seal portion of the flexible seal is generally annular.

5. The fluid separation device of claim 1, further comprising fluid between the outer housing and the rotor, wherein at least a portion of said fluid acts upon the rotor to maintain substantial coaxial alignment between the rotor and the outer housing.

6. A bearing system comprising:
a static body;
a dynamic body which is rotatable about an axis; and
a fluid between the static body and the dynamic body, wherein
rotation of the dynamic body causes at least a portion of the fluid to rotate, and
substantial coaxial alignment between the static body and the dynamic body is achieved by pressure equilibrium of at least a portion of the rotating fluid acting on the rotating dynamic body.

7. The bearing system of claim 6, wherein
the dynamic body is rotatably received within the static body and
an inner region of the dynamic body is in fluid communication with an outer region of the static body while a fluid seal is maintained between an outer region of the dynamic body and an inner region of the static body.

8. The bearing system of claim 6, further comprising a flexible seal associated with one of a first and second end of the dynamic body.

9. The bearing system of claim 8, wherein said flexible seal includes a mounting portion positioned against the static body and a seal portion extending between the mounting portion and the dynamic body.

10. The bearing system of claim 9, wherein the mounting portion of the flexible seal is generally cylindrical and the seal portion of the flexible seal is generally annular.

11. A method of achieving substantial coaxial alignment between a static body and a dynamic body, comprising:
providing a static body, a dynamic body, and a fluid therebetween, with at least one end of the dynamic body being non-rigidly maintained in coaxial alignment with the static body;
rotating the dynamic body about an axis, thereby causing at least a portion of the fluid to rotate; and
achieving substantial coaxial alignment of said at least one end of the dynamic body with the static body by pressure equilibrium of at least a portion of the rotating fluid acting on the rotating dynamic body.

12. The method of claim 11, wherein said providing a static body, a dynamic body, and a fluid therebetween includes positioning the dynamic body so as to be rotatably received within the static body.

13. The method of claim 11, wherein said providing a static body, a dynamic body, and a fluid therebetween includes providing a flexible fluid seal between said at least one end of the dynamic body and the static body.

14. The method of claim 13, wherein the flexible fluid seal includes a mounting portion positioned against the static body and a seal portion extending between the mounting portion and the dynamic body.

15. The bearing system of claim 14, wherein the mounting portion of the flexible fluid seal is generally cylindrical and the seal portion of the flexible fluid seal is generally annular.
